(19) United States
(12) Patent Application Publication
(10) Pub. No.: US 2011/0138612 A1
(43) Pub. Date: Jun. 16, 2011

(54) Jig For Probe Connector

(76) Inventors: Te-Hung Yin, Taipei (TW); Yung-Yi Chen, Taipei (TW); Jui-Pin Lin, Taipei (TW)

(21) Appl. No.: 12/635,442

(22) Filed: Dec. 10, 2009

(51) Int. Cl. B25B 11/02

(52) U.S. Cl. 29/760; 269/287

(57) ABSTRACT

A jig for clutching a plurality of probe assemblies each of which has a connecting portion and a soldering portion has a base body and a covering body. The base body has a plurality of first receiving grooves each penetrating a front end and a rear end thereof. The covering body is formed with a plurality of second receiving grooves corresponding to the first receiving grooves. The covering body is openably fixed on the base body, the first receiving grooves and the second receiving grooves are matched to form a plurality of passageways. A front end of each of the passageways has a portion protruded inwards to form a resisting rib. The connecting portions of the probe assemblies are received in the passageways and abut against the resisting ribs, with tip ends of the soldering potions exposing outside the passageways from rear ends of the passageways.

### BACKGROUND OF THE INVENTION

1. Field of the Invention

The invention relates to a jig, and more particularly to a jig for probe connector.

2. The Related Art

Please refer to FIG. 4, a conventional probe connector 40 includes an insulating housing 41 and a plurality of probe assemblies 42. The insulating housing 41 has a plurality of recesses 411 passing therethrough for receiving the probe assemblies 42. The probe assembly 42 has a circular connecting portion 421. A front end and a rear end of the connecting portion 421 are respectively formed with a telescopic probing pin 422 and a soldering portion 423 soldered to a PCB (not shown) of an electronic device. The probing pin 422 and the soldering portion 423 both are column shape and disposed in alignment with each other. Nevertheless, when the probe assemblies 42 are assembled to the insulating housing 41, the probe assemblies 42 are unable to be exactly positioned in the recesses 411 of the insulating housing 41, which makes the tip ends of the soldering portions 423 of the probe assemblies 42 can not align with each other. The ragged tip ends of the soldering portions 423 are difficult to be soldered to the PCB, which decreases soldering efficiency, furthermore, affects soldering quality. So it is desirable and necessary to design a jig for the probe connector to conveniently assemble the probe assemblies 30 to the insulating housing 20 for solving the problem mentioned above.

### SUMMARY OF THE INVENTION

An object of the present invention is to provide a jig for clutching a plurality of probe assemblies each of which has a connecting portion and a soldering portion connected with an end of the connecting portion. The jig has a base body and a covering body. The base body has a plurality of first receiving grooves each penetrating a front end and a rear end thereof. The covering body is formed with a plurality of second receiving grooves corresponding to the first receiving grooves. The covering body is openably fixed on the base body, the first receiving grooves and the second receiving grooves are matched to form a plurality of passageways. A front end of each of the passageways has a portion protruded inwards to form a resisting rib. The connecting portions of the probe assemblies are received in the passageways and abut against the resisting ribs, with tip ends of the soldering potions exposing outside the passageways from the rear ends of the passageways.

As described above, the probe assemblies are clutched together by the jig. The tip ends of the soldering potions can keep flush with each other, which is convenient for the progress of the soldering and improves the soldering quality and efficiency. So the jig is excellent and can be used widely.

### BRIEF DESCRIPTION OF THE DRAWINGS

The present invention will be apparent to those skilled in the art by reading the following description of an embodiment thereof, with reference to the attached drawings, in which:

FIG. 1 is an assembled, perspective view of a jig of an embodiment in accordance with the prevent invention;

FIG. 2 is an exploded, perspective view of the jig shown in FIG. 1;

FIG. 3 is a perspective view of a covering body of the jig shown in FIG. 2;

FIG. 4 is a perspective view of the conventional probe connector, wherein probe assemblies are not assembled;

FIG. 5 is a perspective view that the jig clutches the probe assemblies, wherein the jig is opened; and

FIG. 6 is a crow-sectional view that the jig is closed, wherein the probe assembly is provided.

### DETAILED DESCRIPTION OF THE EMBODIMENT

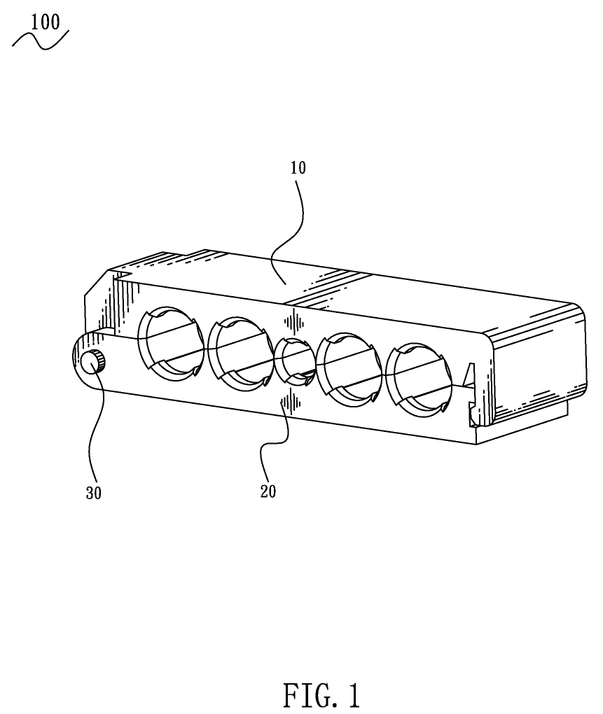

Please refer to FIG. 1, a jig 100 according to the present invention is shown. The jig 100 may be molded by insulating or metal materials and has a rectangular base body 10, a rectangular covering body 20 and a pivot 30.

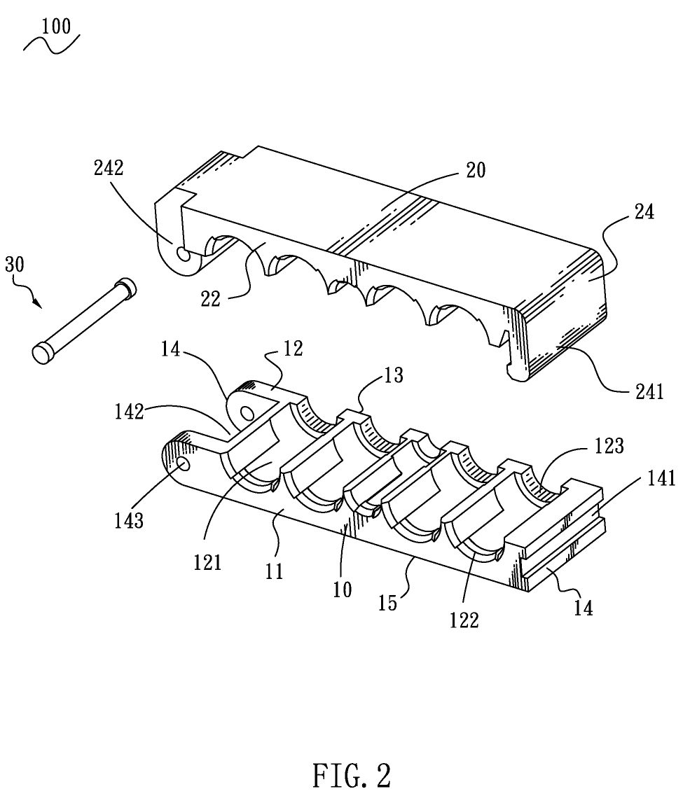

Please refer to FIG. 2, the base body 10 defines a front surface 11, a top surface 12, a rear surface 13, two lateral surfaces 14 and a bottom surface 15. The top surface 12 has a plurality of first receiving grooves 121. Each of the first receiving grooves 121, with a semicircular cross-section, passes through the front surface 11 and the rear surface 13 of the base body 10. The first receiving groove 121 has a first resisting rib 122 protruded upwards from a front end thereof. The first resisting rib 122 spreads along a circular arc of the cross-section of the receiving groove 121 from a lowest point of the first receiving groove 121, with two ends thereof spaced away from the top surface 12, to show an arc shape. A first preventing wall 123 is protruded upwards from a rear end of the first receiving groove 121. The first preventing wall 123 also extends along the circular arc of the cross-section of the receiving groove 121, with two ends thereof connected to the top surface 12, to show a semicircular shape. One lateral surface 14 of the base body 10 has a middle portion concaved inwards to form a buckling recess 141. The buckling recess 141 passes through the base body 10 along an axis of the first receiving groove 121. The other lateral surface 14 of the base body 10 has an inserting recess 142 penetrating through the top surface 12 and the bottom surface 15 of the base body 10. Two facing sides of the inserting recess 142 have two apertures 143 passing therethrough and in alignment with each other. All of the first resisting ribs 122 are disposed in alignment with each other. Herein, the distance between the first resisting rib 122 and the first preventing wall 123 is uniform.

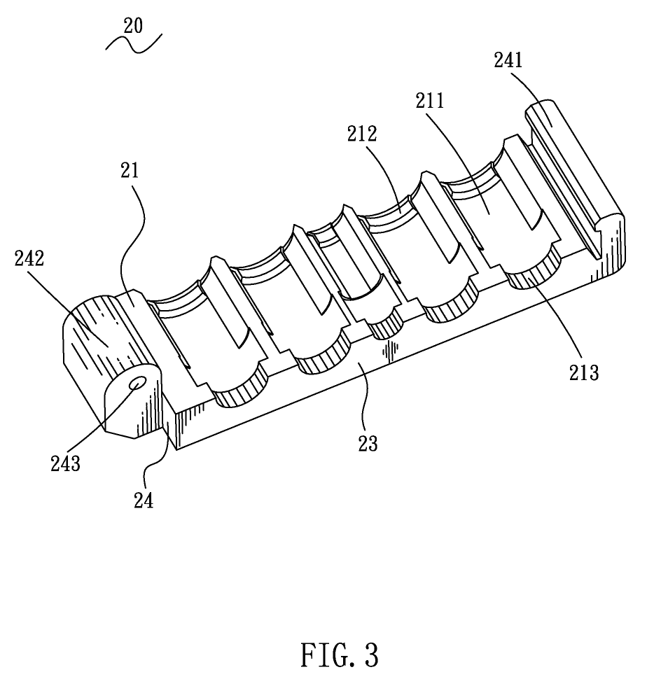

Please refer to FIG. 2 and FIG. 3, the rectangular covering body 20 mounted on the base body 10 defines a bottom surface 21, a front surface 22, a rear surface 23 and two lateral surfaces 24. The bottom surface 21 is formed with a plurality of second receiving grooves 211 corresponding to the first receiving grooves 121. Each of the second receiving grooves 211, with a semicircular cross-section, passes through the front surface 22 and the rear surface 23 of the covering body 20. The second receiving groove 211 has a second resisting rib 212 and a second preventing wall 213 at a front end and a rear end thereof, respectively. The second resisting rib 212 is protruded downwards and alike to the first resisting rib 122 showing an arc shape. The second preventing wall 213 is also a semicircular shape corresponding to the first preventing wall 123. One lateral surface 24 of the covering body 20 is extended downwardly and inwards to form a hooking portion 241. The other lateral surface 24 of the covering body 20 is protruded outwards and downwards to form a block 242. The block 242 is formed with a through hole 243 passing therethrough and corresponding with the two apertures 143 of the inserting recess 142. All of the second resisting ribs 212 are disposed in alignment with each other. Herein, the distance between the second resisting rib 212 and the second preventing wall 213 is uniform.

Please refer to FIGS. 1-3, in assembly, the block 242 is inserted into the inserting recess 142, the pivot 30 passes through the two apertures 143 and the through hole 243 to make the covering body 20 rotatably mount on the base body 10. In closed state, the hooking portion 241 is jammed in the buckling recess 141 to make the covering body 20 be buckled on the base body 10. At this time, the first receiving grooves 121 and the second receiving grooves 211 are matched to form a plurality of passageways 50. It should be noted that the passageways have the same structure and function, and can be changed in the dimension, according to the probe assemblies of the probe connector, by changing the dimension of the first receiving grooves and the second receiving grooves.

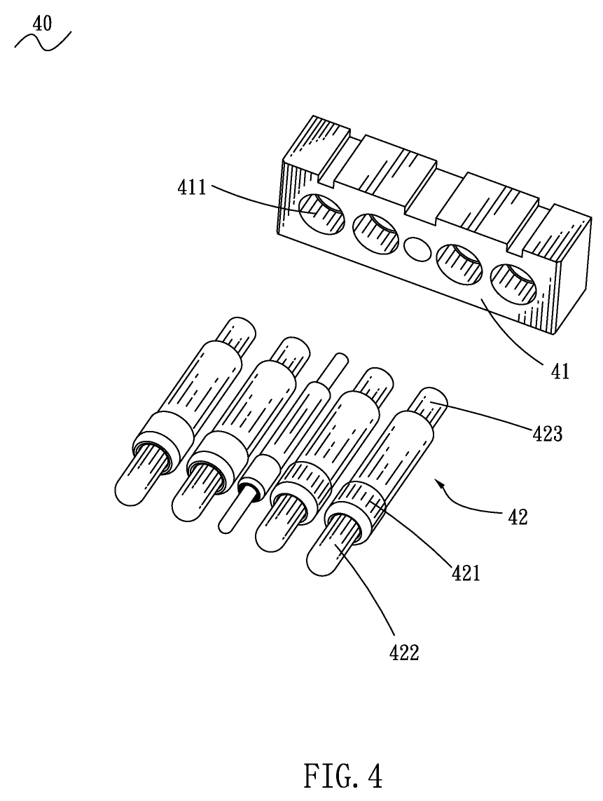

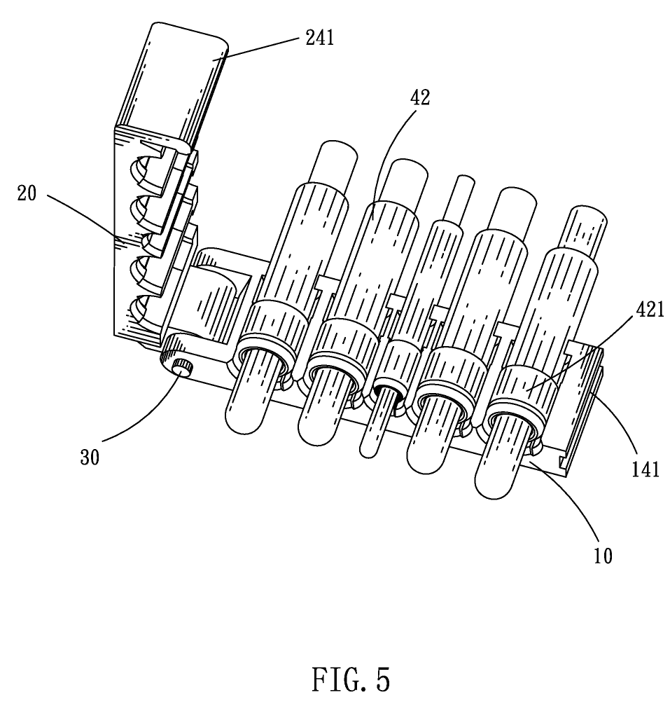

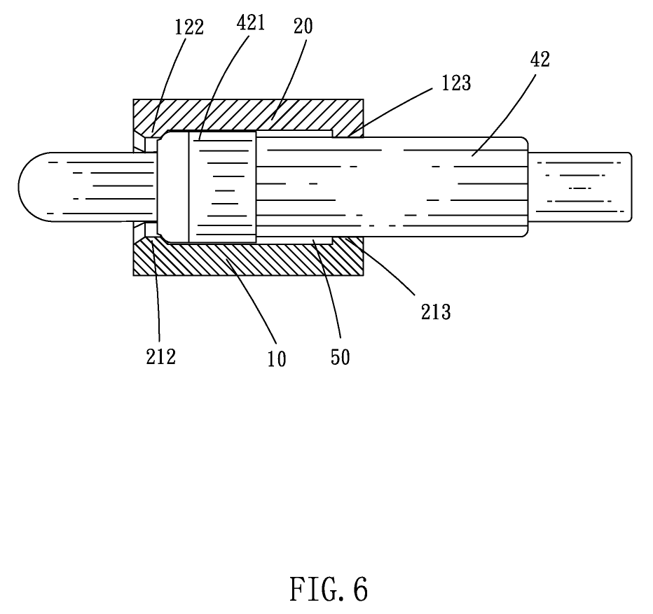

Please refer to FIG. 1 and FIGS. 4-6, when the probe assemblies 42 are mounted to the insulating housing 41 of the probe connector 40, firstly the jig 100 is opened, the connecting portions 421 of the probe assemblies 42 are disposed in the first receiving grooves 121 of the base body 10, then the covering body 20 is rotated to buckle on the base body 10. When the jig 100 is closed, the connecting portions 421 are located between the first resisting ribs 122 and the first preventing walls 123, and between the second resisting ribs 212 and the second preventing walls 213 to prevent the probe assemblies 42 from sliding out of the passageways 50. The soldering portions 423 expose out of the passageways 50. Thus, the soldering portions 423 are inserted into the recesses 411 of the probe connector 40, the connecting portions 421 abut against the first resisting ribs 122 and the second resisting ribs 212, which makes the tip ends of the soldering portions 423 projecting out of the insulting housing 41 be aligned with each other. After the soldering portions 423 are soldered to the PCB, the covering body 20 is opened up, and the jig 100 is separated from the probe assemblies 42.

As describe above, the probe assemblies 42 are clutched together by the jig 100. The tip ends of the soldering potions 423 can keep flush with each other, which is convenient for the progress of the soldering and improves the soldering quality and efficiency. So the jig 100 is excellent and can be used widely.

Furthermore, the present invention is not limited to the embodiment described above; various additions, alterations and the like may be made within the scope of the present invention by a person skilled in the art. For example, respective embodiments may be appropriately combined.

What is claimed is:

1. A jig for clutching a plurality of probe assemblies each of which has a connecting portion and a soldering portion connected with an end of the connecting portion, comprising:
a base body, the base body having a plurality of first receiving grooves each penetrating a front end and a rear end of the base body;
a covering body, the covering body being formed with a plurality of second receiving grooves corresponding to the first receiving grooves,
wherein the covering body is openably fixed on the base body, the first receiving grooves and the second receiving grooves are matched to form a plurality of passageways, a front end of each of the passageways having a portion protruded inwards to form a resisting rib, the connecting portions of the probe assemblies are received in the passageways and abut against the resisting ribs, with tip ends of the soldering potions exposing outside the passageways from rear ends of the passageways.

2. The jig as claimed in claim 1, wherein the passageway has two facing resisting ribs defined as a first resisting rib and a second resisting rib protruded inwards from the first receiving groove and the second receiving groove, respectively.

3. The jig as claimed in claim 2, wherein the passageway has a circular cross-section, the first resisting rib and the second resisting rib are arc shape.

4. The jig as claimed in claim 1, wherein the first receiving groove is formed with a first preventing wall at a rear end thereof, the second receiving groove has a second preventing wall at a rear end thereof, corresponding to the first preventing wall.

5. The jig as claimed in claim 4, wherein the first preventing wall and the second preventing wall are semicircular shape for matching with each other.

6. The jig as claimed in claim 1, wherein one of two lateral ends of the covering body between which the second receiving grooves are located is correspondingly pivotally mounted to one of two lateral ends of the base body between which the first receiving grooves are located.

7. The jig as claimed in claim 6, wherein the one lateral end of the base body has an inserting recess, two facing sides of the inserting recess has two apertures passing therethrough, the one lateral end of the covering body has a block rotatably received in the inserting recess, the block is formed with a through hole, a pivot passes through the apertures and the through hole to make the covering body rotatably mount to the base body.

8. The jig as claimed in claim 6, wherein the other lateral end of the base body has a buckling recess at an outside thereof, the other lateral end of the covering body is extended downwards and inwards to form a hooking portion jammed in the buckling recess when the covering body and the base body are matched with each other.
